(19) United States
(12) Patent Application Publication
(10) Pub. No.: US 2010/0169169 A1
(43) Pub. Date: Jul. 1, 2010

(54) SYSTEM AND METHOD FOR USING TRANSACTION STATISTICS TO FACILITATE CHECKOUT VARIANCE INVESTIGATION

(75) Inventors: Jonathan H. Connell, II, Cortlandt-Manor, NY (US); Myron D. Flickner, San Jose, CA (US); Norman Haas, Mt. Kisco, NY (US); Arun Hampapur, Norwalk, CT (US); Sharathchandra U. Pankanti, Darien, CT (US); Andrew W. Senior, New York, NY (US); Chiao-Fe Shu, Scarsdale, NY (US)

Correspondence Address: Keohane & D'Alessandro, 1881 Western Avenue Suite 180, Albany, NY, 12203, US

(73) Assignee: International Business Machines Corporation, Armonk, NY (US)

(21) Appl. No.: 12/347,129

(22) Filed: Dec. 31, 2008

(51) Int. Cl. G06Q 10/00; G06F 15/18; G06N 5/02

(52) U.S. Cl. 705/11; 706/12; 706/52; 705/30

(57) ABSTRACT

An approach that allows for facilitating checkout related fraud investigation is presented. In one embodiment, there is described a generating tool configured to generate a set of benchmark parameters based on results of a cumulative learning process; a normalizing tool configured to normalize said set of benchmark parameters; an establishing tool configured to establish a confidence time interval required for identifying normal variations; a recording tool configured to record a particular checker's transactions during said confidence time interval, and an identifying tool configured to identify transactions, recorded during said confidence time interval, that fail meeting said set of benchmark parameters.

### FIELD OF THE INVENTION

The present invention generally relates to surveillance systems. Specifically, the present invention provides a method for utilizing transaction logs to improve checkout related theft prevention.

### BACKGROUND OF THE INVENTION

Surveillance systems today provide a whole new level of pro-active control and monitoring. Networked video surveillance technology not only offers superior loss prevention, but it can also be used to boost sales, improve staff and customer security, optimize store layouts, boost productivity, monitor flow control, and to improve many more key functions. Many such surveillance systems also allow for obtaining valuable asset tracking information therefore allowing for improved asset management.

For instance, long term mining of transaction logs and associating such logs with checker's identities can help systematically investigate checker specific variances therefore providing starting points for investigations of checker related fraud. Today, unfortunately, checkout and even more so, self-checkout related fraud are prime examples of the most critical problems relating to growing retail inventory shrinkage.

With increased volumes of shoppers and in-store employees, theft is growing at an alarming rate. In an attempt to detect such theft, many variations of in-store surveillance systems are implemented. Data gathered by such systems is often analyzed and, based on such analysis, further actions are determined. However, as of today no known solutions attack the problem of checkout related fraud comprehensively.

Thus, there exist a need for providing a method and a system for facilitating a checkout variance investigation, such method comprising generating a set of benchmark parameters during a cumulative learning process; normalizing such set of benchmark parameters; establishing a confidence time interval required for identifying normal variations; recording a particular checker's transactions during such time interval, and identifying transactions, recorded during such time interval that fail meeting the set of benchmark parameters.

### SUMMARY OF THE INVENTION

The proposed solution to the existing problem of checkout related fraud detection provides a system and a method that require implementation of three major stages, i.e., learning and relearning, tuning and operation. All these stages will be discussed in greater detail below. It is, however, noted that said learning and relearning as well as tuning is performed as frequently as necessary, but it also depends on a particular store's environment and on cost of such learning/relearning and tuning.

In one embodiment there is a method for facilitating checkout variance investigation, the method comprising: generating a set of benchmark parameters during a cumulative learning process; normalizing the set of benchmark parameters, establishing a confidence time interval required for identifying normal variations; recording a particular checker's transactions during such confidence time interval, and identifying transactions, recorded during the time interval, that fail meeting the set of benchmark parameters.

In a second embodiment, there is a system for facilitating checkout variance investigation, the system comprising: at least one processing unit; memory operably associated with the at least one processing unit; a generating tool storable in memory and executable by the at least one processing unit, the generating tool configured to generate a set of benchmark parameters based on results of a cumulative learning process; a normalizing tool storable in memory and executable by the at least one processing unit, the normalizing tool configured to normalize the set of benchmark parameters; an establishing tool storable in memory and executable by the at least one processing unit, such establishing tool configured to establish a confidence time interval required for identifying normal variations; a recording tool storable in memory and executable by the at least one processing unit, the recording tool configured to record a particular checker's transactions during the confidence time interval, and an identifying tool storable in memory and executable by the at least one processing unit, such identifying tool configured to identify transactions, recorded during the confidence time interval, that fail meeting the set of benchmark parameters.

In a third embodiment, there is a computer-readable medium storing computer instructions, which when executed, enable a computer system to facilitate checkout variance investigation, the computer instructions comprising: generating a set of benchmark parameters during a cumulative learning process; normalizing the set of benchmark parameters, establishing a confidence time interval required for identifying normal variations; recording a particular checker's transactions during such confidence time interval, and identifying transactions, recorded during the time interval, that fail meeting the set of benchmark parameters.

In a fourth embodiment, there is a method for deploying a facilitating tool for facilitating checkout variance investigation, the method comprising: providing a computer infrastructure operable to: generate a set of benchmark parameters during a cumulative learning process; normalize such set of benchmark parameters, establish a confidence time interval required for identifying normal variations; record a particular checker's transactions during such confidence time interval, and identify transactions, recorded during the time interval, that fail meeting the set of benchmark parameters.

### BRIEF DESCRIPTION OF THE DRAWINGS

FIG. 1 shows a schematic of an exemplary computing environment in which elements of the present invention may operate;

FIG. 2 depicts an example of an image of a checker's identification as captured by a camera;

FIG. 3 illustrates the overall process of for facilitating checker fraud investigation;

FIG. 4 depicts a block diagram of the learning process;

FIG. 5 illustrates components of the operation process; and

FIG. 6 shows components of the tuning process.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Embodiments of this invention are directed to a method and a system for facilitating checkout variance investigation. In one embodiment such method comprises: generating a set of benchmark parameters during a cumulative learning process; normalizing the set of benchmark parameters, establishing a confidence time interval required for identifying normal variations; recording a particular checker's transactions during such confidence time interval, and identifying transactions, recorded during the time interval, that fail meeting the set of benchmark parameters.

In a second embodiment, there is a system for facilitating checkout variance investigation, the system comprising: at least one processing unit; memory operably associated with the at least one processing unit; a generating tool storable in memory and executable by the at least one processing unit, the generating tool configured to generate a set of benchmark parameters based on results of a cumulative learning process; a normalizing tool storable in memory and executable by the at least one processing unit, the normalizing tool configured to normalize the set of benchmark parameters; an establishing tool storable in memory and executable by the at least one processing unit, such establishing tool configured to establish a confidence time interval required for identifying normal variations; a recording tool storable in memory and executable by the at least one processing unit, the recording tool configured to record a particular checker's transactions during the confidence time interval, and an identifying tool storable in memory and executable by the at least one processing unit, such identifying tool configured to identify transactions, recorded during the confidence time interval, that fail meeting the set of benchmark parameters.

In a third embodiment, there is a computer-readable medium storing computer instructions, which when executed, enable a computer system to facilitate checkout variance investigation, the computer instructions comprising: generating a set of benchmark parameters during a cumulative learning process; normalizing the set of benchmark parameters, establishing a confidence time interval required for identifying normal variations; recording a particular checker's transactions during such confidence time interval, and identifying transactions, recorded during the time interval, that fail meeting the set of benchmark parameters.

In a fourth embodiment, there is a method for deploying a facilitating tool for facilitating checkout variance investigation, the method comprising: providing a computer infrastructure operable to: generate a set of benchmark parameters during a cumulative learning process; normalize such set of benchmark parameters, establish a confidence time interval required for identifying normal variations; record a particular checker's transactions during such confidence time interval, and identify transactions, recorded during the time interval, that fail meeting the set of benchmark parameters.

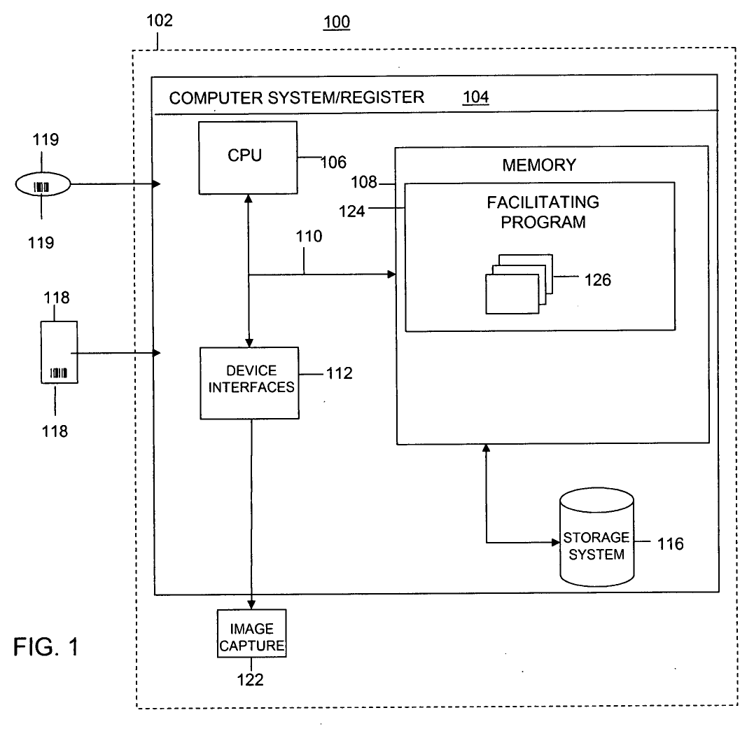

FIG. 1 illustrates a computerized implementation 100 of the present invention. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for detecting and deterring RFID tag related fraud using a color camera based appearance check. It should be understood that any other computers implemented under the present invention may have different components/software, but will perform similar functions. As shown, computer system 104 includes a processing unit 106 capable of analyzing video surveillance, and producing a usable output, e.g., compressed video and video meta-data. Also shown is memory 108 for storing a facilitating program 124, a bus 110, and device interfaces 112.

Computer system 104 is shown communicating with one or more image capture devices 122 that communicate with bus 110 via device interfaces 112.

Processing unit 106 collects and routes signals representing outputs from image capture devices 122 to facilitating program 124. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the video signals may be encrypted using, for example, trusted key-pair encryption. Different capture devices may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)). In some embodiments, image capture devices 122 are capable of two-way communication, and thus can receive signals (to power up, to sound an alert, etc.) from facilitating program 124.

In general, processing unit 106 executes computer program code, such as program code for executing facilitating program 124, which is stored in memory 108 and/or storage system 116. While executing computer program code, processing unit 106 can read and/or write data to/from memory 108 and storage system 116. Storage system 116 stores video metadata generated by processing unit 106, as well as rules and attributes against which the metadata is compared to identify objects and attributes of objects present within scan area (not shown). Storage system 116 can include VCRs, DVRs, RAID arrays, USB hard drives, optical disk recorders, flash storage devices, image analysis devices, general purpose computers, video enhancement devices, de-interlacers, scalers, and/or other video or data processing and storage elements for storing and/or processing video. The video signals can be captured and stored in various analog and/or digital formats, including, but not limited to, Nation Television System Committee (NTSC), Phase Alternating Line (PAL), and Sequential Color with Memory (SECAM), uncompressed digital signals using DVI or HDMI connections, and/or compressed digital signals based on a common codec format (e.g., MPEG, MPEG2, MPEG4, or H.264).

Although not shown, computer system 104 could also include I/O interfaces that communicate with one or more external devices 118 that enable a user to interact with computer system 104 (e.g., a keyboard, a pointing device, a display, etc.).

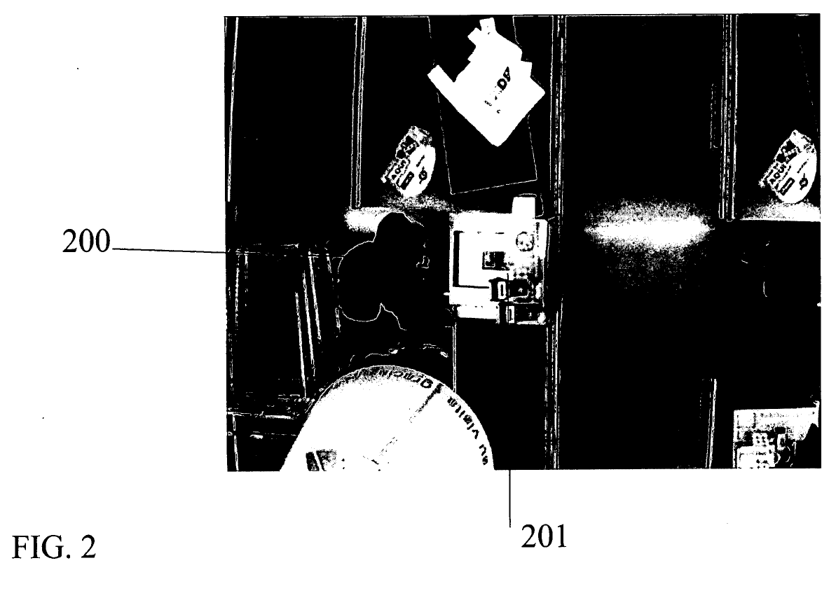

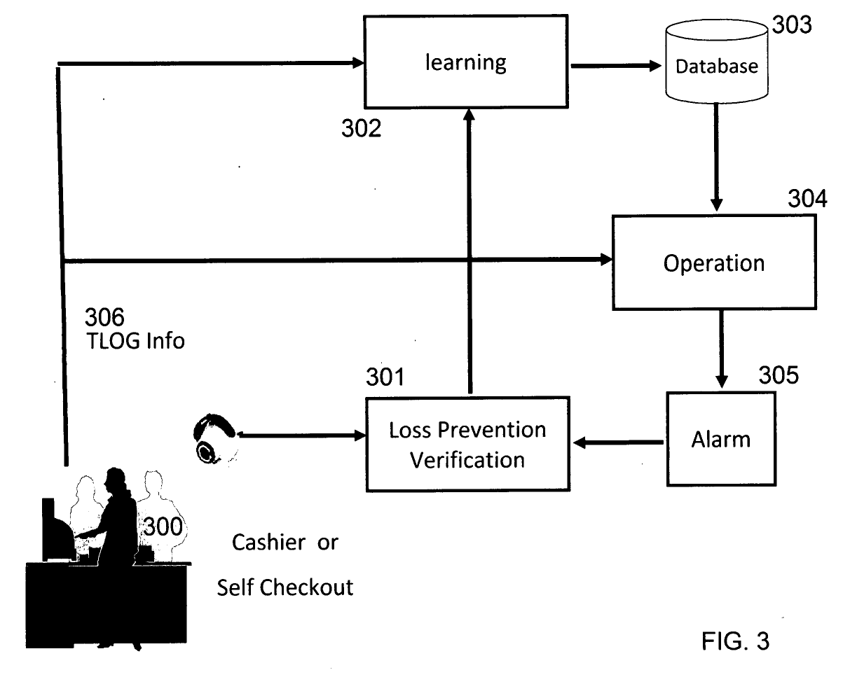

FIG. 2 depicts an example of an image of a checker's identification as captured by a surveillance camera. As illustrated, particular checkout stations code 201 is recorded. Thereafter, visual features of a person administering self-checkout and/or specific name tag or a bar code associated with the particular checker's identity are recorded by the surveillance camera and submitted to database 303 (FIG. 3) for storage.

FIG. 3 illustrates the overall process of facilitating checker fraud investigation. As illustrated, at 301 surveillance system as shown above, records checker's 300 identity and after comparing for loss prevention verification 301 submits the data for learning at 302 to be thereafter recorded and stored in database 303. Further, during performance of operation 304, the data is retrieved as needed and alarm 305 is generated when necessary.

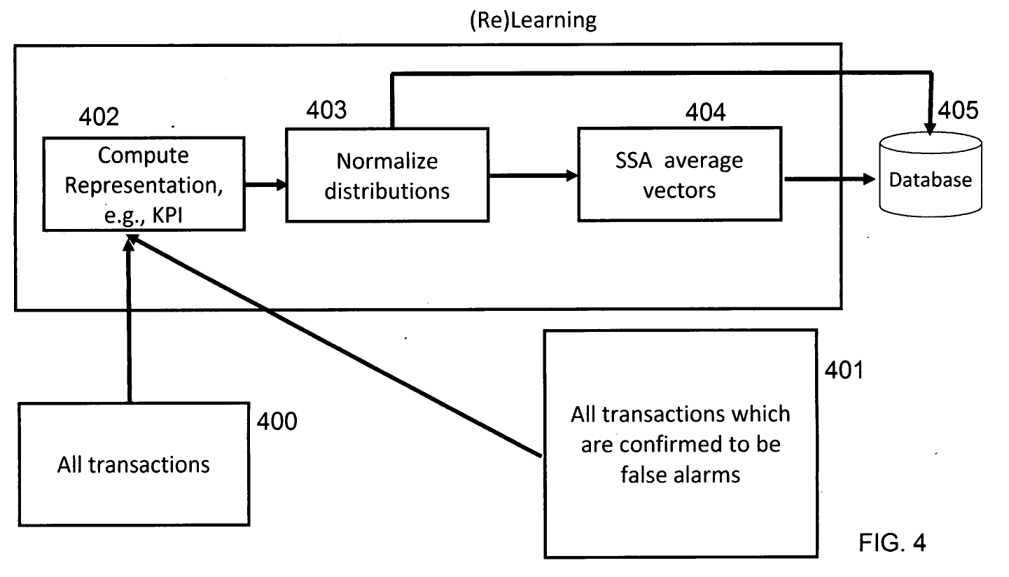

FIG. 4 depicts a block diagram of the learning process. As shown, all transactions 400 are collected and analyzed thereby computing representation by a key performance indicator (KPI) 402. In one embodiment, such KPI is thereafter used as a vector of measurement inclusive of: average gap between two successive item scans; average frequency of item scans; quantized gap histogram, i.e. relationship of the gap to the frequency graph; item price histogram; transactions per unit of time; number of void transactions per unit of time; number of manager overrides per unit of time, and number of price checks per unit of time.

Further, as shown in FIG. 4, the data collected at 402 is adjusted for normalized distributions. As such, samples of KPI vector collected at 402 gathered and adjusted for application of significant store attribute (SSA) at 404. In one embodiment, such SSA data consists of store name, location, size, etc; checkout lane number, cashier's identification; time of day; day of the year; day of the week; cashier's gender; quantized cashier's age, i.e., within 10 year intervals, for example 20-30 years old, and a length of the cashier's experience.

In the preferred embodiment, as shown further in FIG. 4, a KPI weighted Euclidean distance metric is defined. Such metric normalizes the variance of an individual KPI dimension. The normalized data is thereafter stored in database 405. Further, once sufficient amount of samples is gathered, such samples are clustered for each SSA and accumulated. In one embodiment, they are accumulated for a running time window, i.e., predefined time interval, in another embodiment, all such samples are collected “to-date”. Thereafter, normalized baselines are estimated for each SSA in terms of one or more KPI vectors. Such vectors are saved and thereafter used for generating alarms 305 (FIG. 3). The described learning process is repeated with adjustment for false alarms 401 that are identified during sample gathering.

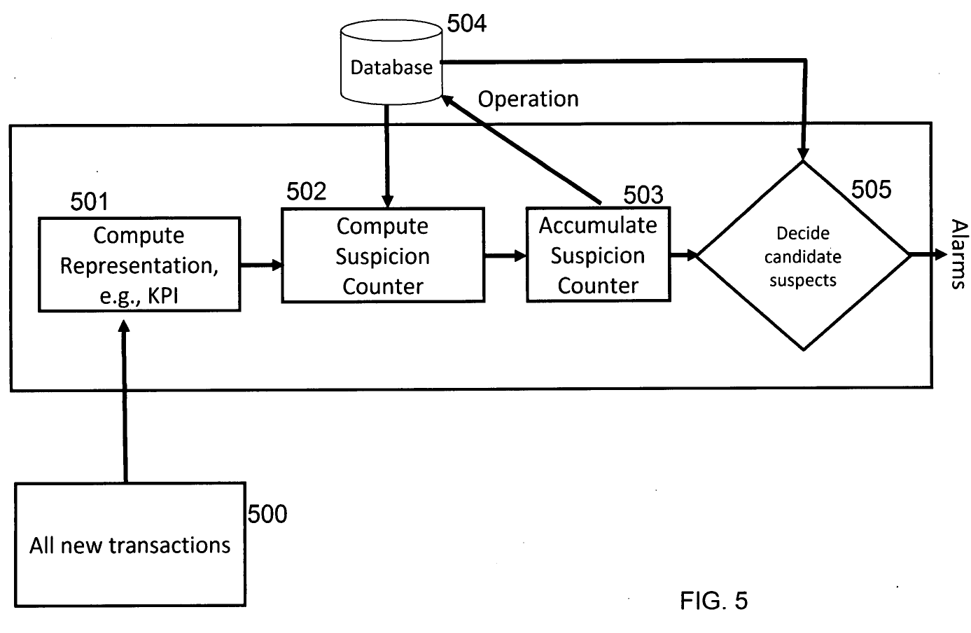

FIG. 5 illustrates components of the operation process. As such, all new transactions 500 are submitted for KPI computation at 501. Once KPI is applied to the transaction log, a compute suspicion counter is determined at 502. Such suspicion counter is accumulated at 503 which thereafter presents required data for identifying a suspect transaction to the database 504. Such data is further analyzed at 505 for identifying said candidate suspect transactions. The operation process thereafter generates an alarm upon acknowledging existence of the suspect transaction.

In the one embodiment, the distance to each of the relevant KPI average vectors is calculated. Further, the distances from each SSA are added to produce a “D” variable. Thereafter, D is compared to a predefined threshold T. If D>T, the suspicion counter associated with the transaction is incremented at 503.

In another embodiment, said suspicion counters are accumulated over extended period of time. In such an embodiment, an alarm is generated when said suspicion counter of a checker is significantly larger than those of the other individuals.

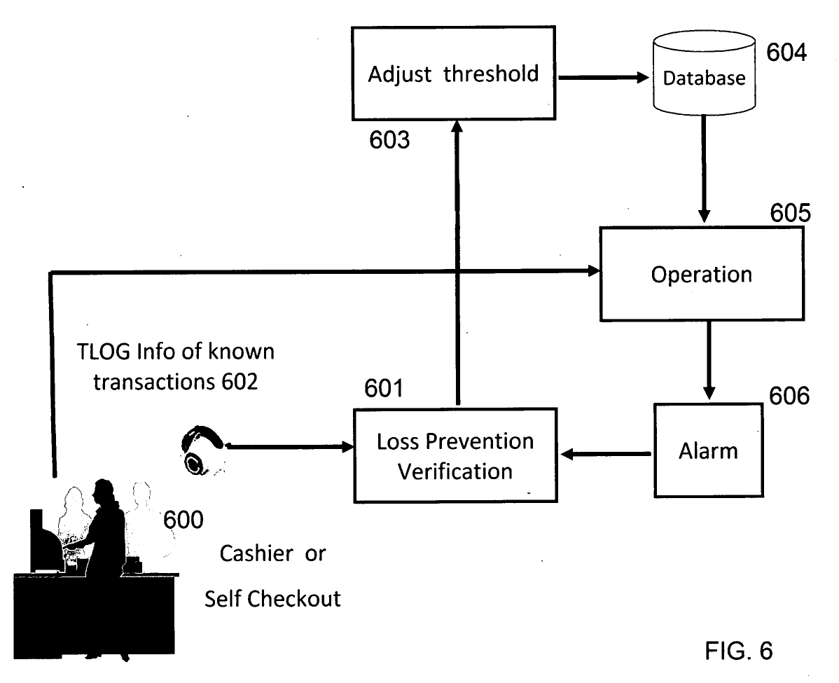

FIG. 6 shows components of the tuning process. As shown, cashier's 600 or self-checkout person's 600 identification is captured by video surveillance and analyzed for loss prevention signs at 601. The transaction log info of known transactions 602 is presented for operation 605. In case no loss prevention signs are identified at 601, threshold is adjusted at 603 for more inclusive data gathering. Thereafter, adjusted data is forwarded to the database 604 for storage and for further use of said data in operation 605 and for possibly generating the alarm at 606. All transactions unrelated to the alarm action and transactions associated with false alarms if verified by the loss prevention module at 601 contribute to the refinement of the average KPI vectors therefore introducing relearning to the tuning process.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

The system and method of the present disclosure may be implemented and run on a general-purpose computer or computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and server. A module may be a component of a device, software, program, or system that implements some “functionality”, which can be embodied as software, hardware, firmware, electronic circuitry, or etc.

What is claimed is:

1. A method for facilitating checkout variance investigation, said method comprising:
generating a set of benchmark parameters based on results of a cumulative learning process;
normalizing said set of benchmark parameters, establishing a confidence time interval required for identifying normal variations;
recording a particular checker's transactions during said confidence time interval, and identifying transactions, recorded during said time interval, that fail meeting said set of benchmark parameters.

2. The method according to claim 1, said generating a set of benchmark parameters further comprising:
collecting a statistical data for a defined checker, lane, store and day of week combination, and
defining a baseline revenue estimate based on said collected data.

3. The method according to claim 1, said normalizing further comprising:
adjusting said collected data with respect to a seasonal spike and a seasonal drop in sales;
adjusting said collected data with respect to a specific event spike and a specific event drop in sales;
adjusting said collected data with respect to a specific store location spike and a specific store location drop in sales; and
adjusting said collected data with respect to a global variation spike and a global variation drop in sales.

4. The method according to claim 1, said cumulative learning process further comprising:
computing a key performance indicator as a vector of measurement for each time stamped transaction log entry; and
storing a sample of said key performance indicator for each significant store attribute.

5. A system for facilitating checkout variance investigation, said system comprising:
at least one processing unit;
memory operably associated with the at least one processing unit;
a generating tool storable in memory and executable by the at least one processing unit, said generating tool configured to generate a set of benchmark parameters based on results of a cumulative learning process;
a normalizing tool storable in memory and executable by the at least one processing unit, said normalizing tool configured to normalize said set of benchmark parameters;
an establishing tool storable in memory and executable by the at least one processing unit, said establishing tool configured to establish a confidence time interval required for identifying normal variations;
a recording tool storable in memory and executable by the at least one processing unit, said recording tool configured to record a particular checker's transactions during said confidence time interval, and
an identifying tool storable in memory and executable by the at least one processing unit, said identifying tool configured to identify transactions, recorded during said confidence time interval, that fail meeting said set of benchmark parameters.

6. The generating tool according to claim 5 further comprising:
a collecting component configured to collect a statistical data for a defined checker, lane, store and day of week combination, and
a defining component configured to define a baseline revenue estimate based on said collected data.

7. The normalizing tool according to claim 5 further comprising:
an adjusting component configured to adjust said collected data with respect to a seasonal spike and a seasonal drop in sales;
an adjusting component configured to adjust said collected data with respect to a specific event spike and a specific event drop in sales;
an adjusting component configured to adjust said collected data with respect to a specific store location spike and a specific store location drop in sales; and
an adjusting component configured to adjust said collected data with respect to a global variation spike and a global variation drop in sales.

8. The cumulative learning tool according to claim 5, further comprising:
computing component configured to compute a key performance indicator as a vector of measurement for each time stamped transaction log entry, and
storing component configured to store a sample of said key performance indicator for each significant store attribute.

9. A computer-readable medium storing computer instructions, which when executed, enable a computer system to facilitate checkout variance investigation, the computer instructions comprising:
generating a set of benchmark parameters during a cumulative learning process;
normalizing said set of benchmark parameters,
establishing a confidence time interval required for identifying normal variations;
recording a particular checker's transactions during said confidence time interval, and
identifying transactions, recorded during said time interval, that fail meeting said set of benchmark parameters.

10. The computer-readable medium according to claim 9 further comprising computer instructions for:
collecting a statistical data for a defined checker, lane, store and day of week combination, and
defining a baseline revenue estimate based on said collected data.

11. The computer-readable medium according to claim 9 further comprising computer instructions for:
adjusting said collected data with respect to a seasonal spike and a seasonal drop in sales;
adjusting said collected data with respect to a specific event spike and a specific event drop in sales;
adjusting said collected data with respect to a specific store location spike and a specific store location drop in sales; and
adjusting said collected data with respect to a global variation spike and a global variation drop in sales.

12. The computer-readable medium according to claim 9 further comprising computer instructions for:
computing a key performance indicator as a vector of measurement for each time stamped transaction log entry; and
storing a sample of said key performance indicator for each significant store attribute.

13. A method for deploying a facilitating tool for facilitating checkout variance investigation, said method comprising:
providing a computer infrastructure operable to:
generate a set of benchmark parameters during a cumulative learning process;
normalize said set of benchmark parameters,
establish a confidence time interval required for identifying normal variations;
record a particular checker's transactions during said confidence time interval, and
identify transactions, recorded during said time interval, that fail meeting said set of benchmark parameters.

14. The method according to claim 13, the computer infrastructure further operable to:
collect a statistical data for a defined checker, lane, store and day of week combination, and
define a baseline revenue estimate based on said collected data.

15. The method according to claim 13, the computer infrastructure further operable to:
adjust said collected data with respect to a seasonal spike and a seasonal drop in sales;
adjust said collected data with respect to a specific event spike and a specific event drop in sales;
adjust said collected data with respect to a specific store location spike and a specific store location drop in sales; and
adjust said collected data with respect to a global variation spike and a global variation drop in sales.

16. The method according to claim 13, the computer infrastructure further operable to:
compute a key performance indicator as a vector of measurement for each time stamped transaction log entry; and
store a sample of said key performance indicator for each significant store attribute.
